(19) United States
(12) Patent Application Publication
(10) Pub. No.: US 2013/0291002 A1
(43) Pub. Date: Oct. 31, 2013

(54) Systems and Methods for Delivery of Media Content

(71) Applicants: Keith Alan Rothschild, Dunwoody, GA (US); Muhammad Asif Raza, Norcross, GA (US)

(72) Inventors: Keith Alan Rothschild, Dunwoody, GA (US); Muhammad Asif Raza, Norcross, GA (US)

(73) Assignee: COX COMMUNICATIONS, INC., Atlanta, GA (US)

(21) Appl. No.: 13/455,610

(22) Filed: Apr. 25, 2012

(51) Int. Cl. H04N 21/458; H04N 21/25; H04N 21/472

(52) U.S. Cl. 725/25; 725/87; 725/34

(57) ABSTRACT

Systems and methods for receiving from a first server a client specific information, transmitting a manifest request to a second server, the manifest request incorporating the client specific information, and receiving from the second server a manifest file. The manifest file may be associated with programming content divided into a plurality of segments. At least one of the plurality of segments may be based in part on the client specific information.

### TECHNICAL FIELD

This invention generally relates to methods, systems, and apparatus for delivery of media content.

### BACKGROUND

Media, such as audio and video, may be delivered to subscribers of media services, such as cable television subscribers, via a communications network, such as a cable television network. In such systems, a content delivery network, or a network of various servers, may provide the media to a client device, such as a set top box at a subscriber location.

Generally, providers or distributers of the media content may monetize their respective services by providing advertising to the subscribers. The advertising content may be provided to the subscriber at predefined available time slots within the media content.

The media is often streamed to the client device. The streaming may be enabled by one or more servers providing programming segments to the client device. Therefore, the streaming media may be segmented into a plurality of segments and the client device may receive each of the segments in a logical or sequential order to provide the viewer with the media content.

### BRIEF DESCRIPTION OF THE FIGURES

Reference will now be made to the accompanying drawings, which are not necessarily drawn to scale, and wherein:

FIG. 1 is a simplified schematic diagram illustrating an example media distribution network that can be operated in accordance with embodiments of the disclosure.

FIG. 2 is a simplified schematic diagram illustrating the example media distribution network of FIG. 1 illustrating components of an application server and an origin server and operating in accordance with embodiments of the disclosure.

FIG. 3 is a flow chart illustrating an example method of requesting media segments based on a manifest file by a client device in accordance with embodiments of the disclosure.

FIG. 4 is a flow chart illustrating an example method for transmitting a manifest file to client device in accordance with embodiments of the disclosure.

FIG. 5 is a simplified diagram illustrating an example manifest file with a series of media segments in accordance with embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the disclosure may provide apparatus, systems, and methods for providing media content to a client device. In one aspect, the media content may be streamed to the client device. In another aspect, the media content may be provided to the client device in a series of media segments. Therefore, if the media segments are played by the client device on an audio/visual output device, in a sequential order, then the client device may provide the media content that is desired by a user of the client device. The client device may receive client specific information from an application server via a communications channel. The client device may further request a manifest file from an origin server based at least in part on a user selection of media. The manifest file request may include the client specific information. The origin server may provide one or more manifest files, or mappings of a sequence of media segments, based at least in part on the client specific information. In one aspect, the manifest file request may be transmitted from the client device to the one or more origin servers via a content delivery network. Similarly, the manifest file may also be delivered from the one or more origin servers to the client device via the content delivery network.

Example embodiments of the disclosure will now be described with reference to the accompanying figures.

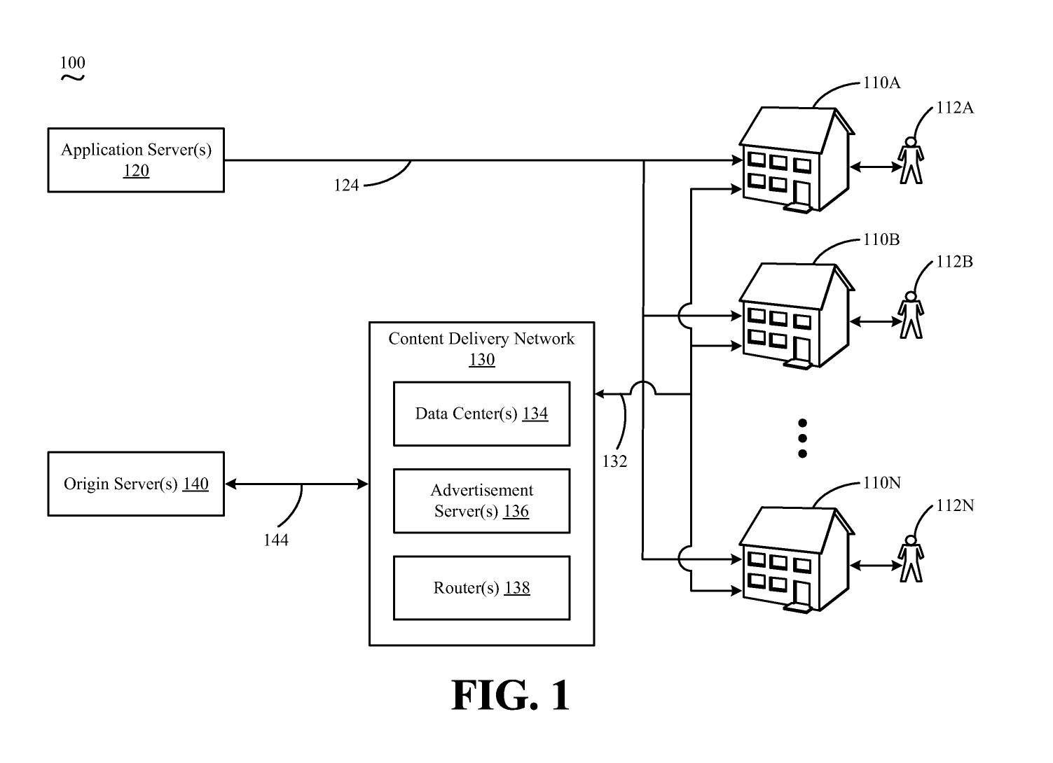

Referring now to FIG. 1, an example media distribution network 100 may include one or more client locations 110A-N where media content may be provided for consumption by one or more corresponding users 112A-N associated with each of the one or more client locations 110A-N. The media distribution network 100 may further include an application server 120 communicatively connected to each of the client locations 110A-N via communicative link 124. A content delivery network (CDN) 130 may be communicatively coupled to the one or more client locations 110A-N via communicative link 132. The CDN 130 may include one or more data centers 134, one or more advertising servers 136, and one or more routers 138. One or more origin servers 140 may further be communicatively coupled to the CDN 130 via communicative link 144.

For the purposes of this discussion the one or more client locations 110A-N may include any variety of locations where media content may be consumed by the one or more users 112A-N, including homes, businesses, schools, hospitals, libraries and the like. In one aspect, the one or more client locations 110A-N may be constrained to a specific geographic area, such as a particular city or state. In other embodiments, the one or more client locations 110A-N may not have geographic constraints. It will be appreciated, that while a single user 112A-N is shown corresponding to each of the one or more client locations 110A-N, there may be any number of users associated with each of the client locations 110A-N. Furthermore, a particular user may be associated with more than one of the client locations 110A-N. For example, an individual may access the media distribution network 100 from two different client locations, such as from a home location and from a work location.

It will be appreciated that while the communicative link 124 has been depicted as a one-way communications link from the one or more applications servers 120 to each of the one or more client locations 110A-N, in certain embodiments of the disclosure, the communicative link 124 may be a two-way communications link. Similarly, while the communicative links 132, 144 have been depicted as a two-way communications links between the CDN 130 and the one or more client locations 110A-N and the one or more origin servers 140 to the CDN 130, respectively, in certain embodiments of the disclosure, the communicative links 132, 144 may be one-way communications links. In certain embodiments, the communicative links 124, 132, 144 may be established via a common medium. In certain aspects, the medium may be coaxial cables, fiber optic cables, hybrid fiber and coaxial cable (HFC), or the like. In certain other aspects, the communicative links 124, 132, 144 may include wireless portions, such as satellite links or microwave communications links. Furthermore, in certain embodiments, communications between any two entities via the communicative links 124, 132, 144 may be protocol based communications, such as transmission control protocol (TCP), internet protocol (IP), hyper text transmission protocol (HTTP), or the like.

The one or more data centers 134 may include one or more servers with processing and electronic storage functionalities. Therefore, each of the one or more data centers 134 may include one or more processors and electronic memories of any suitable variety. In one aspect, the one or more data centers 134 may route data or media or segments thereof through the CDN 130. In another aspect, the one or more data centers 134 may interact with the one or more routers 138 to direct data or media or segments of data or media through the CDN 130. In certain embodiments, the one or more data centers 134 may route media or segments thereof that may be stored on the electronic memory associated with one or more of the data centers 134 trough the CDN 130 to one or more of the client locations 110A-N via communicative link 132. Each of the one or more data centers 134 may be geographically distributed at various suitable locations within a covered geography of the media distribution network 100. The content distribution network 130 may further include one or more advertisement servers 136. Like the one or more data centers 134, the one or more advertisement servers 136 may also route media content or segments thereof to the one or more client locations 110A-N via the one ore more data routers 134 and communicative link 132.

It will be appreciated that the one or more data centers 134 and the CDN 130, in general, may store media content in relatively closer spatial proximity to the client location 110A-N. Therefore, there may be reduced latency in delivery of media content from the CDN 130 to the client location 110A-N than from the one or more origin servers 140 to the client location 110A-N. This placement of media content on the edge, or in relatively closer proximity to the client location 110A-N may also reduce the requirements for bandwidth in portions of the media distribution network 100 for the delivery of relatively high quality media content.

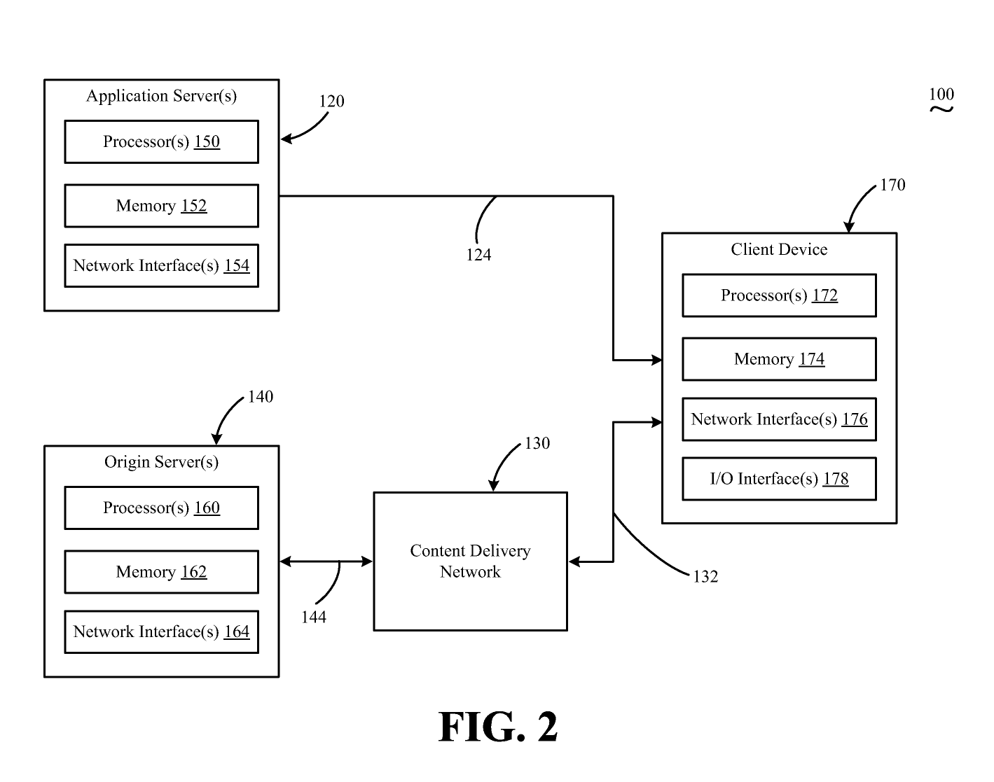

Referring now to FIG. 2 with continuing reference to FIG. 1, further details of the example media distribution network 100 is illustrated and discussed with consideration of an example client device 170 associated with a particular client location. The one or more application servers 120 may include one or more processors 150, communicatively coupled to one or more electronic memories 152 and one or more network interfaces 154. The one or more electronic memories 152 may store information thereon that may be accessed by the one or more processors 150. The information may be any suitable information for delivery of media content via the media distribution network 100, including, but not limited to subscriber information, demographic information, programming information, media distribution network topology information, media content source information, or the like. The one or more network interfaces 154 may be used by the one or more processors 150 to communicate via communicative link 124 to the client device 170. The one or more network interfaces 154 may further be used by the one or more application servers 120 to communicate on any number of additional networks.

The one or more processors 150 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The one or more application servers 120 may also include a chipset (not shown) for controlling communications between the one or more processors 150 and one or more of the other components of the application server 120. In certain embodiments, the application server 120 may be based on processors 150 manufactured by Intel, Advanced Micro Devices, Texas Instruments, Freescale Semiconductor, or the like. The one or more processors 150 may also include one or more application specific integrated circuits (ASICs) or application specific standard products (ASSPs) for handling specific data processing functions or tasks.

The memory 152 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

Still referring to both FIGS. 1 and 2, the origin server 140, may include one or more processors 160, communicatively coupled to one or more electronic memories 162 and one or more network interfaces 164. The one or more network interfaces 164 may be used by the one or more processors 160 to communicate via communicative link 144 to the content distribution network 130. The one or more network interfaces 164 may further be used by the origin server 140 to communicate on any number of additional networks with any variety of other electronic devices. For example, the one or more processors 160 may use the one or more network interfaces 164 to communicate to a headend facility and servers associated therewith. The particular details of the one or more processors 160 and the one or more memories 162 may be similar to the one or more processors 150 and the one or more memories 152, respectively, and in the interest of brevity will not be discussed here.

The one or more electronic memories 162 may store information or media content thereon that may be accessed by the one or more processors 160. In certain embodiments, the origin server 140 may be connected to one or more databases (not shown) to store media files or segments thereof for delivery to the client device 170 via the CDN 130. The media files may be of any suitable form, including data files, video files, audio files, or combinations thereof. In certain aspects, the origin server may provide meta-information in the form of metafiles to the CDN 130. Metafiles may include information pertaining to associated respective media files or segments thereof. For example, metafiles may include information such as file type, file size, file format, or the like. In certain embodiments, the metadata may be a part of the media files and the origin server 140 may provide media files with associated metadata incorporated therein.

In certain other embodiments, the origin server 140 may be part of a headend of a cable television network (not shown). In certain further embodiments, the origin server 140 may be communicatively coupled to a cable television headend facility. In either case, the origin server 140 may receive media content and signals from or within one or more headends during operation. In one aspect, the origin server 140 may process signals associated with media content from one or more headends. For example, the origin server 140 may provide the media content and data files in a format different from the format of media content and data files received from a headend. As a further aspect, the origin server 140 may generate multiple associated files from media content received from a headend, such as media content segments that may be transmitted via a variety of bit rates and a variety of formats. For example, the formats may include any suitable format, including, but not limited to, Apple® hyper text transmission protocol (HTTP) Live Streaming (HLS)®, Microsoft® Silverlight Smooth Streaming (SS)®, Adobe® HTTP Adaptive Streaming (HDS)®, Moving Picture Expert's Group (MPEG)® Dynamic Adaptive Streaming with HTTP (DASH)®, or combinations thereof. In certain cases, high bit rate and high quality media files may be transmitted via the CDN 130 to a client device that is suited to receive the high bit rate files in a streaming fashion. Portions of the media distribution network 100 may be suitable for delivery of the high bit rate media content. Other portions of the media distribution network 100 may be suited for only a lower bit rate transmission. Furthermore, particular client devices may be suited for receiving higher bit rate media content transmissions than other client devices on the media distribution network 100. For example, various portions of the media distribution network 100 and client devices and, therefore, client locations 110A-N may be suited for different levels of MPEG-4 file transmissions, with unique streaming rates. Accordingly, the origin server 140 may provide various associated versions of media content to the CDN 130 for distribution to the client device 170.

In one aspect, the origin server 140 may provide media content, or segments thereof, to the CDN 130 for storage thereon. In particular, the media content provided by the one or more origin servers 140 may be stored on the one or more data centers 134, one or more advertisement servers 136, or both. In certain aspects, the media content delivered by the media distribution network 100 may be primarily stored, or cached, in the CDN 130, and servers 134, 136 and databases associated therewith.

The one or more origin servers 140 may further be communicatively coupled to an advertisement management server (not shown) or an advertisement decision server (not shown). The advertisement management server may provide advertisement content or segments thereof to the one or more origin servers 140.

During operation, the one or more origin servers 140 may further be configured to provide the client device 170 with a manifest file or a playlist file. In one aspect, the manifest file may be provided by the one or more origin servers 140 to the client device via the CDN 130 over the communicative links 132 and 144. The manifest file may be generated by the one or more origin servers 140 in response to a programming request by the client device 170. The manifest file may, in one aspect, provide information related to identification of segments of media content that the client device 170 needs to acquire and the sequence of the same. Therefore, the manifest file may provide a sequential listing of files that the client device 170 needs to receive from the CDN 130 to correctly render media content to the one or more users 112A-N.

With continuing reference to both FIGS. 1 and 2, the client device 170, may be located in one of the client locations 110A-N and may include one or more processors 172, communicatively coupled to one or more electronic memories 174, one or more network interfaces 176, and one or more input-output (I/O) interfaces 178. The client device 170 may be any variety of suitable devices, such as devices configured to receive media content from the media delivery network 100 and present the content to a user 112A-N. The client device may include, for example, a set top box, a personal computer, a tablet computer, a laptop computer, a smart phone, a personal digital assistant, or the like. In general, the client device 170 may include or may be communicatively coupled to a display screen (not shown) to render images or a repeated sequence of images such as video to the user 112A-N. The client device 170 may further include or may be communicatively coupled to a speaker (not shown) to render sounds to the user 112A-N.

The particular details of the one or more processors 172 and the one or more memories 174 may be similar to the one or more processors 150, 160 and the one or more memories 152, 162, respectively, and in the interest of brevity will not be discussed here.

The one or more network interfaces 176 may be used by the one or more processors 172 to communicate via communicative link 132 to the CDN 130 and the communicative link 124 to the one or more application servers 120. The one or more network interfaces 176 may further be used by the client device 170 to communicate on any number of additional networks with any variety of other electronic devices. For example, a smart phone may communicate with both the media delivery network 100, as well as a cellular telephone network. In operation, the one or more network interfaces 176 may be used to receive, for example, client specific information from the application server 120, transmit a manifest file request to the one or more origin server 120 via the CDN 130, receive a manifest file from the one or more origin server 140 via the CDN 130, or receive media content, or segments thereof, from the CDN 130.

The I/O interface 178 may be any apparatus or mechanism by which a user 112A-N may interact with the client device 170. Some non-limiting examples of the same may include a remote controller to provide input to and control a set top box, a television communicatively coupled to the set top box for providing visual or audio output to a user 112A-N, a keyboard or mouse to provide input to control a laptop computer, or a touch screen and micro-electromechanical system (MEMS) based accelerometers for providing input to and receiving output from a smart phone.

It will be appreciated that while only one client device 170 is shown, there may be any number of client devices on the media delivery network 100. In fact, each client location 110A-N may have one or more client device 170 associated therewith. For example, a particular household may have two cable set top boxes in two different rooms, a desk top computer, a laptop computer, a tablet computer, and three smart phones associated therewith. Each device may be able to independently access the media delivery network to access media content therefrom.

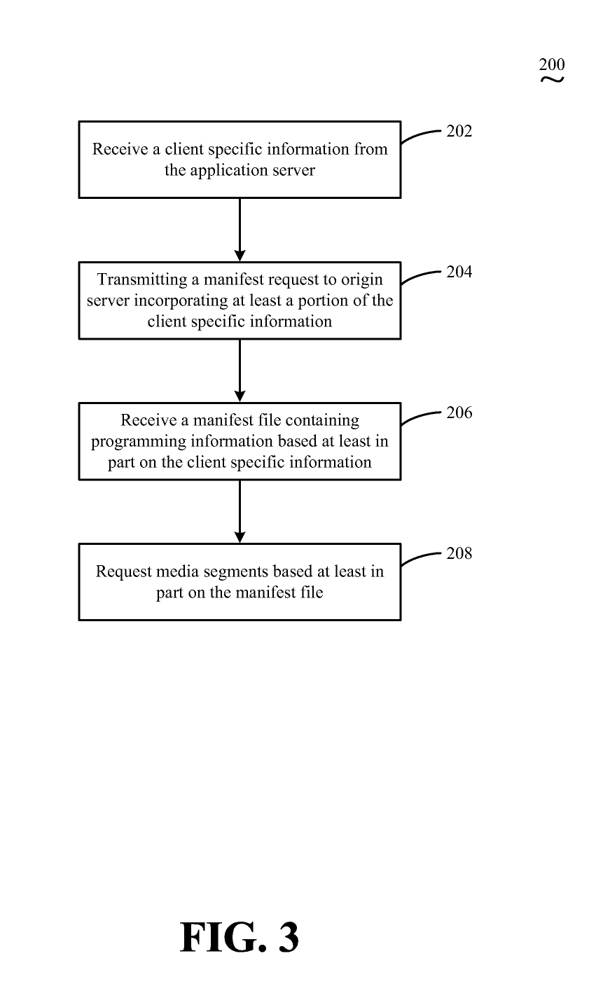

Referring now to FIG. 3, an example method 200 for requesting media segments in accordance with embodiments of the disclosure is discussed. The functional blocks of the method 200 may be performed by the client device 170 located at a client location 110A-N. At block 202, client specific information may be received from the application server. In one aspect, the client specific information may be stored at the application server 120 in the memory 152 or in a supplemental database (not shown) of client specific information. The client specific information may be accessed by the one or more processors 150 from the memory 152 or supplemental database and transmitted by the application server 120 using the network interface 154 via the communicative pathway 124 to the client device 170. The client device 170 may receive the client specific information via the one or more network interfaces 176 and provide the same to the one or more processors 176. The one or more processors 172 may, in turn, store the client specific information on the one or more memories 174.

The client specific information may include a variety of suitable information, such as demographic information and client device type. Such information may include, but is not limited to, number of people in a household, gender of people in the household, age of people in the household, race of people in the household, religion of people in the household, sexual orientation of people in the household, political views of people in the household, product or service preferences of people in the household, client device type, or combinations thereof. The client specific information may further include, data associated with and indicative of the viewing patterns of the media content, viewing times of media content, user interactions with the client device 170, changes in the viewing patterns of household, or combinations thereof. It will be appreciated that the knowledge of such information, such as demographic information, as contained in the client specific information may be used to provide more user specific media content. In particular, the client specific information may aid in providing more relevant advertising content to the user 112A-N.

The client specific information may be provided by the one or more application servers 120, in certain embodiments, when the client device 170 joins the media delivery network 100. In one aspect, when the client device joins the media delivery network 100, the client device may provide electronic credentials and authentication information to ensure its authority to join the media delivery network 100. The credentials may be provided to the one or more application servers 120 and in response the one or more application servers 120 may provide the client device 170 with client specific information.

In certain other embodiments, the one or more application servers 120 may periodically provide updated client specific information to the client device 170. For example, the one or more application servers 120 may provide updated client specific information to the client device 170 at predetermined times. In one aspect, the one or more application servers 120 provide updated client specific information at different times to different client devices associated with different client locations 110A-N.

In yet another embodiment, the one or more application servers 120 may provide updated client specific information upon turning on or activating the client device 170. For example, consider that a user 112A-N turns on a set top box to watch television at her client location 110A-N. Upon turning on the set top box, updated client specific information may be sent to the client device 170 from the one or more application servers 120.

In certain embodiments, the client specific information may not be static. In other words, the client specific information may change over time, based on any variety of factors. For example, the client information may be updated based upon most recent viewing patterns and content delivery tracking from a particular client device. The one or more processors 150 of the one or more application servers 120 may update the client specific information based on new data provided to it, such as recent media content requests by the user 112A-N. Indeed, the one or more application servers 120 may access the one or more processors 172 of the client device 170 to access such updated data associated with the user 112A-N and the media content provided to the client device 170. Alternatively, the one or more application servers 120 may access the one or more origin servers 140 or the CDN 130 to determine the media content that have been provided to the client device 170. In certain embodiments, detailed client specific information may be generated by the one or more processors 150 of the one or more application servers 120. The client specific information may be refined over time based on viewing habits at a particular client location 110A-N and client device 170. Over time, the client specific information may provide greater accuracy and precision with regards to the viewing habits at a particular client device. In certain embodiments, the client specific information may incorporate temporal information, such as types of programming that may be accessed at a particular client device at various days and times of the day. In certain further embodiments, the client specific information may be coded into a particular set of codes that are associated with particular demographics of the viewership associated with a client device. In other words, the client specific information may be coded into specific demographic buckets.

As a non-limiting example, consider an application server that receives viewing information for a client device. The application server may process the received viewing information to ascertain that particular viewing habits. The application server may find that the client device may be used to access children's cartoons on weekend mornings, sports programming during weekend afternoons and evenings, and soap operas during weekday afternoons. Based on this viewing trend, client specific information may be assigned that is indicative of school age children, a sports enthusiast, and a stay at home parent. The client specific information may be encoded in a particular code indicative of the determined demographic information. For example, the code associated with the prior example, may be different than a code that may be assigned to a client device or household that views on situational comedies during prime time on weekdays.

In further embodiments, client specific information may be updated or refined by providing a survey to users of a particular client device. The users may enter information about their household, via, for example, the client device. The survey response information may be transmitted to the application server and the application server may use the same to generate or refine client specific information.

It will be appreciated form the above discussion that client specific information may provide knowledge of user 112A-N preferences and interests. Accordingly, client specific information may be useful in targeting advertisement content within the media content provided to the user 112A-N.

The client specific information may be sent by the one or more applications servers 120, and the one or more processors 150 therein, in the form of a data packet. The data packet may contain, amongst other things, routing information for the destination client device 170, a payload containing the client specific information, and one or more transmission integrity checks, such as a parity bit or a cyclic redundancy check (CRC). The data packet may be assembled by the one or more processors 150 at the one or more application servers 120 and the payload may be extracted by the one or more processors 172 at the client device 170.

It will be appreciated that in certain embodiments the client specific information may be generated by the client device 170. In other words, the one or more processors 172 of the client device 170 may generate the client specific information or an encoded indication of the client specific information. In one aspect an encoded indication of the client specific information may be decoded by other elements of the media distribution network 100.

At block 204, a manifest request incorporating at least a portion of the client specific information may be transmitted to the origin server. In one aspect, the manifest request may be a data packet that is generated by the one or more processors 172 of the client device 170. In addition to the client specific information, the manifest request may include information pertaining to media content or programming requested by the user 112A-N of the client device 170. Therefore, the one or more processors 172 may access the one or more memories 174 or registers associated with the one or more processors and retrieve the most recent client specific information that was received by the client device 170 whenever the client device 170 makes a manifest request.

In one aspect, the client device 170 may transmit a manifest request when a user requests a new media content. As a result, if a the user 112A-N requests a new program for viewing or listening, the one or more processors 172 may generate a new manifest request and transmit the same to the one or more origin servers 140 via the one or more network interfaces 176, the communicative link 132, the CDN 130, and the communicative link 144. In yet other embodiments a portion of the client specific information, indication of the client specific information, or a coded representation of the client specific information may be included in the manifest request.

In certain embodiments, the client specific information may be provided in the header of the manifest request data packet. In certain other embodiments, the client specific information may be stored remotely from the client device 170 and the client device may provide a mechanism or address, such as a universal resource locator (URL) to the one or more origin servers 140 to retrieve the client specific information.

As a non-limiting example, consider that a user 112A-N requests a particular program from a media on demand (MOD) selection associated with a set top box. The one or more processors 172 in the set top box may generate a manifest request in the form of a data packet. The manifest request may incorporate an identifier of the particular program that is requested by the user 112A-N, as well as, the most recent client specific information received by the set top box from the one or more application servers 120 or a portion or representation thereof. The manifest request may further contain a header with routing information and transmission error checks, such as CRC.

At block 206, a manifest file containing programming information and based at least in part on the client specific information may be received. The manifest file may be generated by the one or more origin servers 140 and in particular the one or more processors 160 of the one or more origin servers 140. The one or more origin servers 140 may receive the manifest request from the client device and extract the media programming request, as well as, the client specific information therefrom and use the same to generate the manifest file. The information may include, media segment pointers, addresses, identifiers, or the like.

The manifest file, sometimes referred to as a playlist, may include information pertaining to segments of media that are to be streamed to the client device 170 to provide the media programming that is requested by the user 112A-N. In other words, the manifest file, when provided to the client device 170, allows the client device, and more particularly, the one or more processors 172, to access segments of media from the CDN 130 in a particular sequence as indicated in the manifest file to provide a complete media content to the user 112A-N of the client device 170. For example, a ten minute media content or programming may be partitioned in to 300 media segments. In one aspect, the manifest file provided to the client device 170 may include information associated with accessing each of the 300 media segments in the correct order to provide complete media content to the user 112A-N.

In one aspect, the one or more processors 160 may determine, based on the media programming requested, which segments of media may need to be transmitted to the client device 170. The determination may be based upon the use of a look-up table stored in the one ore more memories 162 or additional databases of the one or more origin servers 140. In particular, the one or more origin servers 140 may generate a listing and identification for each of the media segments that will be needed by the client device 170 to render the media content to the user 112A-N. The identifier may be a unique name or address of a particular media segment where the name or address may be used by a client device 170 to retrieve the media segment from the CDN 130.

In certain embodiments of the disclosure, the manifest file may be provided with segments that include advertising content. In other words, the sequence of the programming may include the media content requested by the user 112A-N by interacting with the client device 170, as well as advertising content provided with the requested media content. For example, advertising segments may be inserted within and amongst the segments of the media content provided by the one or more origin servers 140 may reflect the same. The determination of which advertising content to insert within the programming may be made by the one or more processors 160 of the one or more origin servers 140 based at least in part on the client specific information as provided within the manifest request transmitted by the client device 170 at block 204.

As a non-limiting example, the one or more origin servers 140, may get an indication based at least in part on the client specific information that users associated with a particular client device may include elementary school aged children. The indication may be ascertained by the one or more processors 160 of the one or more origin servers based at least in part on the client specific information. As a result, the one or more origin servers 140 may insert advertisement segment identifiers or pointers within the manifest file associated with advertising related to toys or other products and services of interest to children.

As another non-limiting example, the one or more origin servers 140, may get an indication based at least in part on the client specific information that users associated with a particular client device may include a sports enthusiast. As a result, the one or more origin servers 140 may insert advertisement segment identifiers or pointers within the manifest file associated with advertising related to sporting goods or sporting event tickets.

As a further non-limiting example, the one or more origin servers 140, may get an indication based at least in part on the client specific information that users associated with a particular client device may include a home owner. As a result, the one or more origin servers 140 may insert advertisement segment identifiers or pointers within the manifest file associated with do-it-yourself home maintenance and home repair, appliances, yard equipment, or the like.

As yet a further non-limiting example, the one or more origin servers 140, may get an indication based at least in part on the client specific information that users associated with a particular client device may include an automobile enthusiast. As a result, the one or more origin servers 140 may insert advertisement segment identifiers or pointers within the manifest file such as car advertisements.

In certain embodiments of the method 200, targeted advertising may only be provided if a customer of the media delivery network 100 chooses to participate. Therefore users 112A-N may be asked specifically if they wish to “opt-in.” In one aspect, a user 112A-N may interact with the client device 170 to solicit an indication of the user's desire to participate. If a user wishes to participate, then the same may be communicated to one or more application servers 120 or the one or more origin servers 140, or both. In one aspect, the one or more origin servers 120 may provide the client specific information to the client device only if the respective user 112A-N has “opted-in.” In certain other embodiments, the manifest request sent from the client device 170 to the one or more origin servers 140 may have a field that can indicate to the one or more origin servers 140 if the corresponding user 112A-N has agreed to participate. In certain embodiments, incentives may be provided to users 112A-N for opting in. Incentives may include, any suitable benefit to the user 112A-N, including, for example, reduced subscription rates for using the media delivery network 110 or reduced frequency of advertising.

It will be appreciated that in certain embodiments, the programming and advertising to be provided by the client device 170 to the user 112A-N, and the segments thereof, may be identified in more than one manifest file. In other words, the one or more origin servers 140 may generate more than one manifest files based on a single manifest request. Additionally, in certain embodiments, the manifest file may be updated by the one or more origin servers 140 based on a variety of factors including availability of media segments and bandwidth available for transmitting media segments over the media delivery network 100. Put another way, one or more origin servers 140 may provide a first manifest file to the client device 170 responsive to a manifest request from the client device 170. However, the one or more origin servers 140 may later generate a new or updated manifest file for the client device 170 for any variety of reasons, and then transmit the same to the client device 170 to replace the first manifest file. For example, the one or more origin servers 140, may generate a new manifest file if new media segments related to the user 112A-N requested programming are made available subsequent to sending the first manifest file.

Continuing on with FIG. 3, at block 208, media segments may be requested based at least in part on the received manifest file. In other words, the client device 170 may use information, such as identifiers of media segments, such as segment names, pointers, or addresses provided in a manifest file to retrieve the media segments in succession from the CDN 130. In an example, the manifest file may include a universal resource locators (URLs) where one or more media segments may be located. In one aspect, the client device 170 may provide an identifier of the next segment of media to be retrieved from the CDN 130 based on the manifest file. Upon providing the identifier of the next segment of media, the CDN 130 may find the media segment and serve or stream the same to the client device 170. The identifier of media segments may be provided by the client device 170 via communicative link 132 and the media segment may be received by the client device 170 using the same communicative link 132.

The media segments received by the client device 170 responsive to the request for the same according to the manifest file may originate from either the one or more data centers 134 or the one or more advertisement servers 136. In one aspect, programming content may originate from the one or more data centers 134 and the advertisement segments may originate from the one or more advertising servers 136. The media content may be routed via one or more routers 138 and transmitted via the communicative link 132, received by the one or more network interfaces 176 of the client device 170, and provided to the one or more processors 172. The one or more processors 176 may directly provide the media content to I/O interfaces 178, such as a display screen or speakers or it may cache the media content on the one or more memories 174 to ensure an interruption free running of the programming. In some cases, the one or more processors 172 may need to convert or decode the format of the media content segments received to provide electrical signals to I/O interfaces 178 to render the media programming correctly.

In certain embodiments, adaptive bit rate methods may be used for retrieval of media content. Accordingly, the CDN 130 may in real time or near real time assess the bandwidth available for transmitting the media segments requested by the client device 170 and then serve files of video or audio quality, size, and of bandwidth requirements that are appropriate for the available bandwidth. Therefore, the client device 170 may receive media segments that are of a variety of quality and the quality of the same may be dynamically determined by the CDN 130.

It will be appreciated that the embodiments shown provide for the client device 170 receiving a manifest that includes both programming media content, as well as, advertising media content. Therefore, the client device 170 has a seamless mechanism for retrieving all the segments of media that it provides to the end user based on one or more associated manifest files. In other words, the client device 170 does not need to locate and react to avails, or time spans within the programming where advertisements may be inserted. Therefore, the client device does not need to fetch advertising segments from a separate server when there are avails indicated in a manifest file. The manifest file itself provides for advertising content so the client device can access the advertising content in a seamless way, similar to how it accesses the media programming content. Furthermore, the decision on which media content to insert in the programming is not made by the client device 170, but rather by the one or more origin servers 140. The advertising content, therefore, is not the same for all users 112A-N, but may be customized for each client device and/or associated users 112A-N. The customization may be performed by the origin server at the time when the manifest file is generated for the client device 170 based on the client specific information or in updated or new manifest files. It will further be appreciated that targeted advertising, may allow media providers and distributors, such as cable television companies, to better monetize their media content, other intellectual and creative properties, and their distribution infrastructure.

It should be noted, that the method 200 may be modified in various ways in accordance with certain embodiments of the disclosure. For example, one or more operations of method 200 may be eliminated or executed out of order in other embodiments of the disclosure. Additionally, other operations may be added to method 200 in accordance with other embodiments of the disclosure.

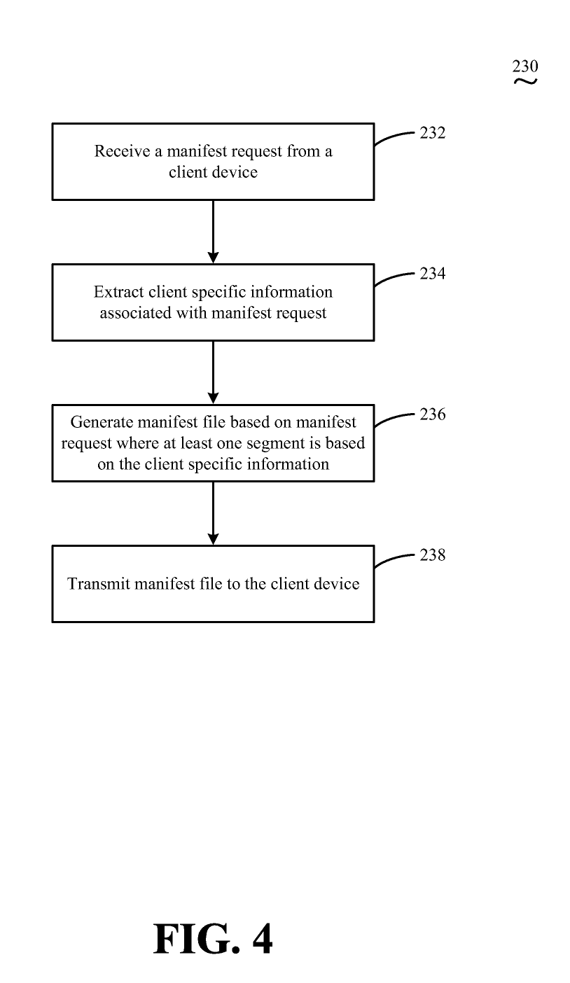

Referring now to FIG. 4, an example method 230 for transmitting a manifest file to a client device in accordance with embodiments of the disclosure is illustrated. Generally, the procedures of this method may be performed by the one or more origin servers 140. At block 232, a manifest request is received from a client device. As describe in reference to block 204 of method 200 in FIG. 3, the manifest request may be generated by the client device 170 and may include client specific information, or portion or indicator thereof, associated with the particular client device sending the manifest request.

At block 234, the client specific information may be extracted from the manifest request. As discussed with reference to FIG. 3, the manifest request may be in the form of a data packet incorporating the client specific information that was provided to the client from the one or more application servers 120. Upon receiving the manifest request from the client device 170, the one or more origin servers 140 may identify the client specific information and extract the same from the data packet for use in analyzing for the purpose of determining what media and/or advertisement content to be provided in the manifest file. Therefore, at block 236, the manifest file may be generated based on the manifest request where at least one segment identified in the manifest file is based at least in part on the client specific information provided in the manifest request.

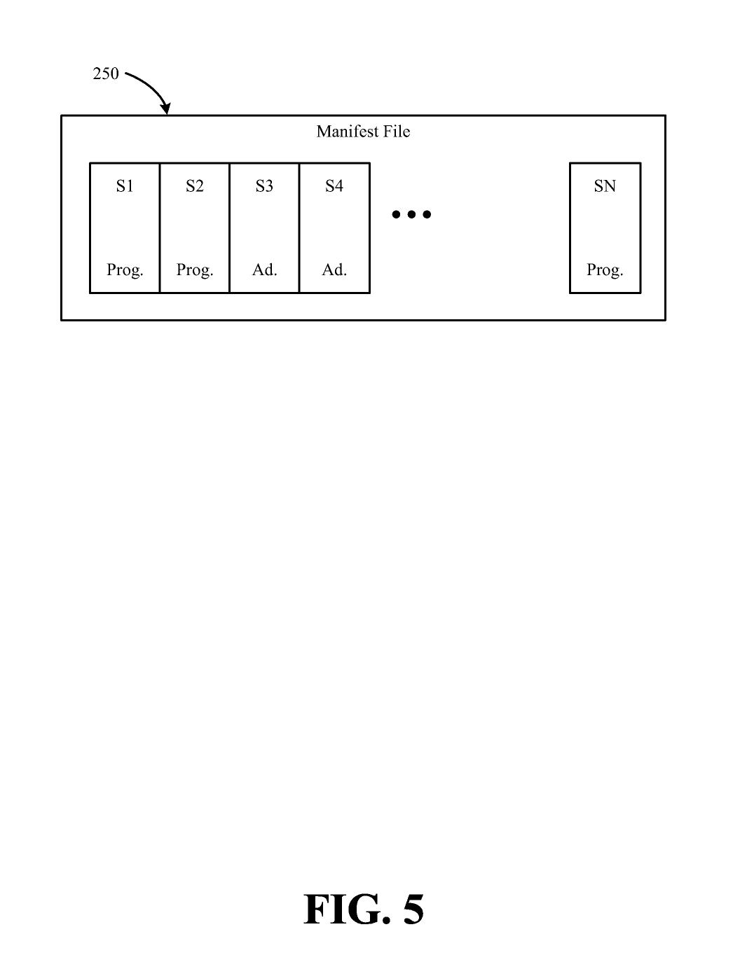

The at least one segment based on client specific information may be an advertising segment, and more particularly, a targeted advertising segment. FIG. 5 graphically illustrates an example sequence of media segments in time that may be played by the client device based upon the manifest file 250. Therefore, the manifest file 250 generated by the one or more origin servers 140 may provide pointers to the media segments. As shown on the manifest file 250, there may be N number of segments to SN. Some of the segments may be programming segments, such as S1, S2, and SN, and other segments may be advertising segments, such as S3 and S4, as depicted.

Continuing on with reference to FIG. 4, at block 238, the manifest file may be transmitted to the client device. As described in reference to FIG. 3, the communication of the manifest file may be via communicative links 144, 132, and CDN 130.

It should be noted, that the method 230 may be modified in various ways in accordance with certain embodiments of the disclosure. For example, one or more operations of method 230 may be eliminated or executed out of order in other embodiments of the disclosure. Additionally, other operations may be added to method 230 in accordance with other embodiments of the disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
transmitting, by a client device comprising one or more processors, a manifest request to a first server, the manifest request incorporating at least a portion of a client specific information; and
receiving, by the client device from the first server, a manifest file,
wherein the manifest file provides information about a plurality of media segments, wherein at least one of the plurality of media segments is based at least in part on the at least a portion of the client specific information.

2. The method of claim 1, further comprising receiving, by a client device from a second server, the client specific information.

3. The method of claim 2, wherein the second server is an application server configured to authenticate the client device.

4. The method of claim 1, wherein the client specific information comprises at least one of: (i) user related information; or (ii) client device related information.

5. The method of claim 4, wherein the user related information comprises at least one of: (i) an occupation of a client; (ii) a client geography; (iii) a client viewing history; (iv) a client viewing genre; (v) a client age; (vi) a number of people in a client household; (vii) a primary language of a client; (viii) a profession of a client; (ix) an income of a client; (x) a race of a client; (xi) an education level of a client; (xii) a product purchased by a client; (xiii) a service purchased by a client; (xiv) a credit history of a client; (xv) a driving history of a client; (xvi) a criminal history of a client.

6. The method of claim 4, wherein the client device related information comprises at least one of: (i) a client device type; (ii) a client device model; (iii) a client device maker; (iv) a client device technical specifications; (v) number of other client devices at a client household; (vi) types of client devices at a client household.

7. The method of claim 1, wherein the manifest request further comprises information associated with a user selected media content.

8. The method of claim 7, wherein the plurality of media segments comprises at least a portion of the user selected media content.

9. The method of claim 1, wherein the second server is an origin server and is communicatively coupled to the client device via a content delivery network.

10. The method of claim 1, wherein the one or more of the plurality of media segments are advertising segments.

11. The method of claim 8, wherein the advertising segments are identified by the second server based at least in part on at least a portion of the client specific information.

12. The method of claim 1, further comprising requesting, by the client device, the at least one of the plurality of media segments based at least in part on the manifest file.

13. The method of claim 1, further comprising receiving, by the client device, the at least one of the plurality of segments.

14. A method comprising:
receiving, by a server comprising one or more processors, a manifest request from a client device, the manifest request comprising at least a portion of client specific information;
determining, by the server, based at least in part on the at least a portion of the client specific information, a plurality of media segments associated with the client device;
generating, by the server, a manifest file based at least in part on the plurality of media segments;
transmitting, by the server, the manifest file to the client device.

15. The method of claim 14, wherein the client specific information comprises at least one of: (i) user related information; or (ii) client device related information.

16. The method of claim 14, wherein the manifest request further comprises information associated with a user selected media content.

17. The method of claim 14, wherein the one or more of the plurality of media segments are advertising segments.

18. A system comprising:
a first server configured to transmit client specific information to a client device; and,
a second server communicatively coupled to the client device and configured to receive a manifest request incorporating the client specific information from the client device and generate a manifest file based at least in part on the client specific information,
wherein the manifest file is further associated with a programming content and provides information on a plurality of media segments associated with the programming content.

19. The system of claim 18, further comprising the client device communicatively coupled to the first server and configured to receive the client specific information and generate the manifest request incorporating at least a portion of the client specific information.

20. The system of claim 18, wherein at least one of the plurality of the media segments is an advertising segment and the advertising segment is selected by the second server based at least in part on the client specific information.
